(19) United States
(12) Patent Application Publication
(10) Pub. No.: US 2015/0260979 A1
(43) Pub. Date: Sep. 17, 2015

(54) IMAGE ACQUISITION APPARATUS AND CONTROL METHOD THEREOF

(71) Applicant: CANON KABUSHIKI KAISHA, Tokyo (JP)

(72) Inventor: Hiroshi Saito, Ayase-shi (JP)

(21) Appl. No.: 14/640,298

(22) Filed: Mar. 6, 2015

(30) Foreign Application Priority Data
Mar. 13, 2014 (JP) 2014-050257
Dec. 24, 2014 (JP) 2014-260713

(51) Int. Cl. G02B 21/36

(52) U.S. Cl. CPC G02B 21/367; G02B 21/361

(57) ABSTRACT

An image acquisition apparatus comprises a modifying unit that modifies a relative position between a specimen and a plurality of reference planes. The modifying unit modifies the relative position such that a minimum value of a distance in an optical axis direction between one of a plurality of positions within the specimen in which the plurality of reference planes exist following modification of the relative position and one of a plurality of positions within the specimen in which the plurality of reference planes exist prior to modification of the relative position is equal to or smaller than a first threshold, and a plurality of imaging units acquire a plurality of image data corresponding to the plurality of reference planes in each relative position.

### BACKGROUND OF THE INVENTION

1. Field of the Invention

The present invention relates to an image acquisition apparatus, and more particularly to an image acquisition apparatus for acquiring images of multiple layers that exhibit little relative position deviation between the layers in an in-plane direction.

2. Description of the Related Art

An image acquisition apparatus that acquires a digital image by photographing a specimen has gathered attention in the fields of pathology and so on as an alternative to an optical microscope. With this apparatus, a doctor can diagnose a pathological condition using acquired image data. This type of apparatus is known as a digital microscope system, a slide scanner, a virtual slide system, and so on. By digitizing a pathological diagnosis image, cell shapes can be learned, cell numbers can be calculated, and an area ratio between the cytoplasm and the nucleus can be calculated, for example. As a result, various types of useful information for making a pathological diagnosis can be provided.

Meanwhile, a cell has a thickness dimension, and therefore the doctor must make a pathological diagnosis while taking into consideration a distribution of structures such as the cell nucleus in a thickness direction (a Z direction). Hence, in an image acquisition apparatus having an optical system with a shallow depth of focus, such as a microscope, for example, structures are detected while moving a stage carrying the specimen in the Z direction in order to determine a Z range (a height range) in which images are to be acquired. Images of a plurality of layers are then obtained within the Z range while minutely adjusting the height of the stage. An omnifocal image that is in focus over an entire region, and a three-dimensional image from which the distribution of structures in the thickness direction can be learned, are then constructed from the plurality of images captured in this manner. The images of the respective layers may be referred to as layer images, and a group of layer images acquired from a plurality of layers may be referred to as a Z stack image.

However, when the stage is moved in the Z direction, the stage may move in an XY direction (a perpendicular direction to the Z direction) as well as the Z direction such that the region of the acquired image varies in each Z direction position of the stage. When an omnifocal image and a three-dimensional image are constructed without taking the possibility of this region variation into account, an omnifocal image and a three-dimensional image including distortion that does not exist in the specimen are acquired. Therefore, when the omnifocal image and the three-dimensional image constructed without taking the possibility of region variation into account are used, it becomes more difficult to make a precise diagnosis. For example, when the presence of an abnormality in the cell nucleus is diagnosed on the basis of the shape of the cell nucleus, it is impossible to determine whether distortion existing in the omnifocal image and the three-dimensional image is distortion existing in the cell nucleus or distortion caused by the region variation described above.

Japanese Patent Application Publication No. 2013-020140, for example, discloses a technique developed in consideration of this problem. Japanese Patent Application Publication No. 2013-020140 discloses an image processing apparatus that is capable of detecting and correcting positional deviation between planes that are perpendicular to a height direction among images of a specimen having different height directions so that an omnifocal image and a three-dimensional image can be constructed with a high degree of precision.

However, in the technique disclosed in Japanese Patent Application Publication No. 2013-020140, positional deviation is detected on the basis of images having different height directions. It is therefore impossible, with the technique disclosed in Japanese Patent Application Publication No. 2013-020140, to determine whether the detected positional deviation is caused by distortion existing in the specimen or distortion caused by the region variation described above, and as a result, positional deviation may be detected erroneously.

A technique disclosed in Japanese Patent Application Publication No. H7-005370 is also available as related art relating to the acquisition of images of a plurality of layers. Japanese Patent Application Publication No. H7-005370 discloses a multi-surface simultaneous measurement microscope apparatus in which an observation/measurement range in a thickness direction of a specimen can be widened by splitting an optical path of an objective lens, and disposing a light receiving surface of imaging means in a conjugate position relative to a plurality of predetermined positions of the objective lens.

Even when the technique disclosed in Japanese Patent Application Publication No. H7-005370 is used, however, the stage must be moved in the Z direction to observe and measure a specimen having a thickness that exceeds the range that can be observed and measured by simultaneous measurement. Therefore, the problem described above (variation of the image region) occurs likewise when the technique disclosed in Japanese Patent Application Publication No. H7-005370 is used.

### SUMMARY OF THE INVENTION

The present invention has been designed in consideration of the circumstances described above, and an object thereof is to provide a technique with which images of multiple layers exhibiting little relative position deviation between the layers in an in-plane direction can be acquired using a simple method, thus enabling accurate diagnostic imaging.

A first aspect of the present invention resides in an image acquisition apparatus comprising: an optical system that collects light from a specimen; a splitting unit that splits an optical path from the optical system into a plurality of optical paths; a plurality of imaging units that have light receiving surfaces respectively on the plurality of optical paths, a plurality of reference planes, which are specimen side surfaces that are optically conjugate with the respective light receiving surfaces, being positioned at different heights on the specimen side; and a modifying unit that modifies a relative position between the specimen and the plurality of reference planes in an optical axis direction of the optical system, wherein the modifying unit modifies the relative position such that a minimum value of a distance in the optical axis direction between one of a plurality of positions within the specimen in which the plurality of reference planes exist following modification of the relative position and one of a plurality of positions within the specimen in which the plurality of reference planes exist prior to modification of the relative position is equal to or smaller than a first threshold, and the plurality of imaging units acquire a plurality of image data corresponding to the plurality of reference planes in each relative position.

A second aspect of the present invention resides in a control method of an image acquisition apparatus including: an optical system that collects light from a specimen; a splitting unit that splits an optical path from the optical system into a plurality of optical paths; and a plurality of imaging units that have light receiving surfaces respectively on the plurality of optical paths, a plurality of reference planes, which are specimen side surfaces that are optically conjugate with the respective light receiving surfaces, being positioned at different heights on the specimen side, the control method comprising the steps of: modifying a relative position between the specimen and the plurality of reference planes in an optical axis direction of the optical system such that a minimum value of a distance in the optical axis direction between one of a plurality of positions within the specimen in which the plurality of reference planes exist following modification of the reference position and one of a plurality of positions within the specimen in which the plurality of reference planes exist prior to modification of the relative position is equal to or smaller than a first threshold, and acquiring a plurality of image data corresponding to the plurality of reference planes in each reference position using the plurality of imaging units.

According to the present invention, images of multiple layers exhibiting little relative position deviation between the layers in an in-plane direction can be acquired using a simple method, thus enabling accurate diagnostic imaging.

Further features of the present invention will become apparent from the following description of exemplary embodiments with reference to the attached drawings.

### BRIEF DESCRIPTION OF THE DRAWINGS

FIG. 1 is a schematic view of an image acquisition apparatus according to a first embodiment;

FIG. 2 is a view showing a unit arrangement of the image acquisition apparatus;

FIG. 3 is a block diagram showing functions of a control unit;

FIG. 4 is a view showing a hardware configuration of the control unit;

FIG. 5 is a view illustrating a relationship between an observation subject layer and reference planes of a specimen;

FIG. 6 is a flowchart showing overall processing of the image acquisition apparatus;

FIG. 7 is a flowchart showing processing for acquiring an image of the observation subject layer within a Z acquisition subject range;

FIG. 8 is a flowchart showing processing for calculating a Z movement sequence of a stage;

FIG. 9 is a schematic view of an image acquisition system according to a second embodiment;

FIG. 10 is a block diagram showing functions of a control unit according to the second embodiment;

FIG. 11 is a flowchart showing overall processing of the image acquisition system according to the second embodiment;

FIG. 12 is a schematic view of an image acquisition apparatus according to a third embodiment; and

FIG. 13 is a view illustrating a relationship between an imaging sequence and the reference planes according to the third embodiment.

### DESCRIPTION OF THE EMBODIMENTS

Embodiments of the present invention will be described below with reference to the drawings. In the description of the embodiments, a digital microscope (a slide scanner) and a slide (also referred to as a preparation) are cited as preferred examples of an image acquisition apparatus and a specimen subjected to image acquisition, respectively, but the scope of the present invention is not limited particularly thereto. Further, unless noted otherwise, the scope of the present invention is not limited to numerical values cited as specific examples in the following description.

Note that in the drawings, identical members have been allocated identical reference numerals, and duplicate description thereof has been omitted.

### First Embodiment

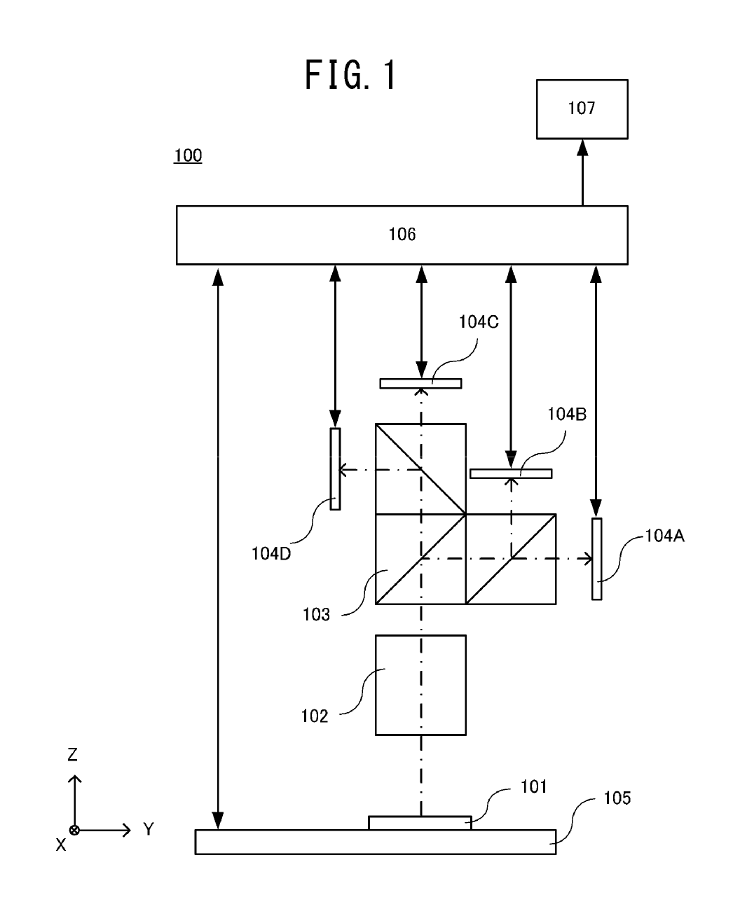

An image acquisition apparatus according to a first embodiment of the present invention will now be described using FIG. 1.

(Configuration of Image Acquisition Apparatus)

FIG. 1 is a view showing a configuration of an image acquisition apparatus 100 according to the first embodiment. The configuration of the image acquisition apparatus 100 will be described on the basis of FIG. 1. In the following description, a Z direction is defined as an optical axis direction of an objective lens 102 constituting an optical system, and an XY direction is defined as a perpendicular direction to the optical axis. The Z direction also matches a height direction (a thickness direction) of a specimen.

The image acquisition apparatus 100 includes the objective lens 102, an optical path splitting unit 103, imaging units 104A to 104D, a stage 105, a control unit 106, and a display unit 107. The objective lens 102 is an optical system that collects light (transmitted light or reflected light) from a slide 101 serving as the specimen. The optical path splitting unit 103 is splitting means that splits luminous flux from the objective lens into four optical paths. The imaging units 104A to 104D serve as a plurality of imaging means disposed on respective optical axes of the split optical paths. The stage 105 serves as modifying means for holding and moving the slide 101. The control unit 106 serves as control means for controlling the image acquisition apparatus 100 to generate image data for display. The display unit 107 serves as display means for displaying a digital image. An XYZ position of the slide 101 is moved and controlled by the stage 105 such that four layers of the slide 101 having different heights are photographed simultaneously by the imaging units 104A to 104D via the objective lens 102 and the optical path splitting unit 103.

The slide 101 is a preparation specimen obtained by disposing a specimen (a biological specimen such as a tissue section or the like) on a slide glass and fixing the specimen using a mounting agent and a cover glass.

The objective lens 102 is constituted by a combination of a lens and a mirror, and is held by a main body frame, not shown in the drawing, and a lens barrel. The objective lens 102 constitutes, together with the optical path splitting unit 103, an image forming optical system that forms optical images of the slide 101 on respective light receiving surfaces of the imaging units 104A to 104D. Further, the objective lens 102 enlarges the optical images of the slide 101 by a predetermined magnification so that the optical images are projected at an identical enlargement ratio onto the light receiving surfaces of all of the imaging units 104A to 104D. A depth of field of the objective lens 102 is between approximately 1 μm (micrometer) and several μm, i.e. extremely narrow.

The optical path splitting unit 103 is an optical system that is held by the main body frame, not shown in the drawing, or the lens barrel of the objective lens 102 in order to split luminous flux from the objective lens 102 into four optical paths oriented toward the imaging units 104A to 104D. The optical path splitting unit 103 is configured and disposed such that an entire visual field of the objective lens 102 is projected onto the respective light receiving surfaces of the imaging units 104A to 104D.

The imaging units 104A to 104D are held by the main body frame, not shown in the drawing, or the lens barrel of the objective lens 102, and constituted by (two-dimensional) imaging devices such as CCDs or CMOS sensors. By using high resolution sensors, images having a wide range and high spatial resolution can be obtained simultaneously. In this embodiment, a full size CMOS having a 6.4 μm (micrometer) pitch is combined with the 25.6 times objective lens 102 so that 0.25 μm/pixel images are acquired simultaneously from a 1.4 mm×0.9 mm region. The respective light receiving surfaces of the four imaging units 104A to 104D are disposed on the four split optical paths splitted by the optical path splitting unit 103. In this specification, for the objective lens 102, specimen side (object side) surfaces in optically conjugate positions relative to the respective light receiving surfaces of the imaging units 104A to 104D will be referred to as “reference planes”. By varying Z direction (optical axis direction) positions of the four reference planes corresponding to the four imaging units 104A to 104D, layers of the slide 101 in different Z positions can be photographed simultaneously. Downloading of output data from the imaging units 104A to 104D is controlled by the control unit 106.

The stage 105 includes a holding portion for holding the slide 101, an XY stage for moving the holding portion in the XY direction in accordance with a control target value output from the control unit 106, and a Z stage for moving the holding portion in the Z direction (not shown). A stage that can be driven over a wide range equal to or greater than 25 mm is preferably employed as the XY stage in particular. The XY stage may be constituted by a direct-acting system or the like that is driven by a linear motor, a DC motor using a direct-acting ball screw, a pulse motor, a VCM, or the like. Meanwhile, a stage that can be driven at a positioning precision of 0.1 μm or less is preferably employed as the Z stage in particular. The Z stage may be constituted by a direct-acting system driven by a linear motor, a stage using a direct-acting guide, a DC motor using a direct-acting ball screw, a pulse motor, a VCM, or the like, a plate spring guide mechanism and a mechanism using a piezo actuator, and so on.

An XY relative position between the slide 101 and the objective lens 102 is modified by moving the XY stage, and in so doing, a divided image of a desired region of the slide 101 can be obtained. Further, by acquiring divided images repeatedly while controlling XY movement continuously, a wide range of the slide 101 can be photographed. An XY movement sequence for acquiring images from a wide range is determined on the basis of an XY acquisition subject range. The XY acquisition subject range is information defining an XY range (a region breadth) of the specimen from which images are to be acquired. The XY acquisition subject range may be determined on the basis of information indicating an XY shape of the specimen, which is measured in advance using a preliminary measurement system, not shown in the drawing, or as required on the basis of an instruction from a user. By setting the XY acquisition subject range, image data from a region requiring pathological diagnosis or the like can be generated selectively, and in so doing, regions in which the specimen does not exist and so on, for example, can be deleted, thereby reducing a volume of image data for display. As a result, the data can be handled more easily. Note that normally, the XY acquisition subject region is determined to be equal to the region in which the detected specimen exists.

Meanwhile, Z relative positions between the slide 101 and the four reference planes are modified by moving the Z stage, and in so doing, images of four layers of the slide 101 having different heights (depths) can be acquired simultaneously. Hereafter, the Z relative positions between the slide 101 and the four reference planes will be described simply as the “Z relative position”. Further, by acquiring images repeatedly while controlling Z movement continuously, images of four or more layers can be acquired from the same XY region. In other words, the imaging units 104A to 104D can acquire images of four or more layers from the same XY region by capturing four images corresponding to the four reference planes in each Z relative position. This processing will be referred to as multi-layer image acquisition processing. A Z movement sequence during the multi-layer image acquisition processing is determined on the basis of a Z acquisition subject range. The Z acquisition subject range is information defining a Z range (a height range) of the specimen in which images of multiple layers are to be acquired, and can be determined on the basis of autofocus processing. Note that the Z acquisition subject range may also be determined on the basis of Z shape information measured in advance using a preliminary measurement system, not shown in the drawing, or on the basis of an instruction from the user. The Z shape information expresses a Z direction shape of the specimen. Note that in this embodiment, as an example, the Z relative position between the slide 101 and the four reference planes of the objective lens 102 is modified by moving the Z stage, but the objective lens 102 or the imaging units 104A to 104D may be moved instead.

The control unit 106 is constituted by a general-purpose computer or workstation that includes a CPU, a memory, a hard disk, and so on and is capable of high-speed calculation processing, a dedicated graphics board, or a combination thereof. The control unit 106 includes an interface on which to input and output control information and image data into and from the stage 105, the imaging units 104A to 104D, and the display unit 107. The control unit 106 may also include an interface on which to modify settings of the image acquisition apparatus 100 and an interface on which to input position information and shape information relating to the specimen. Functions of the control unit 106, to be described below, are realized by loading a program stored on a storage medium such as a hard disk to the memory, and having the CPU execute the program.

The display unit 107 has a function for displaying an observation image suitable for pathological diagnosis on the basis of the image data for display generated by the image acquisition apparatus 100. The display unit 107 may be constituted by a CRT monitor, a liquid crystal monitor, or the like.

(Splitting an Optical Path)

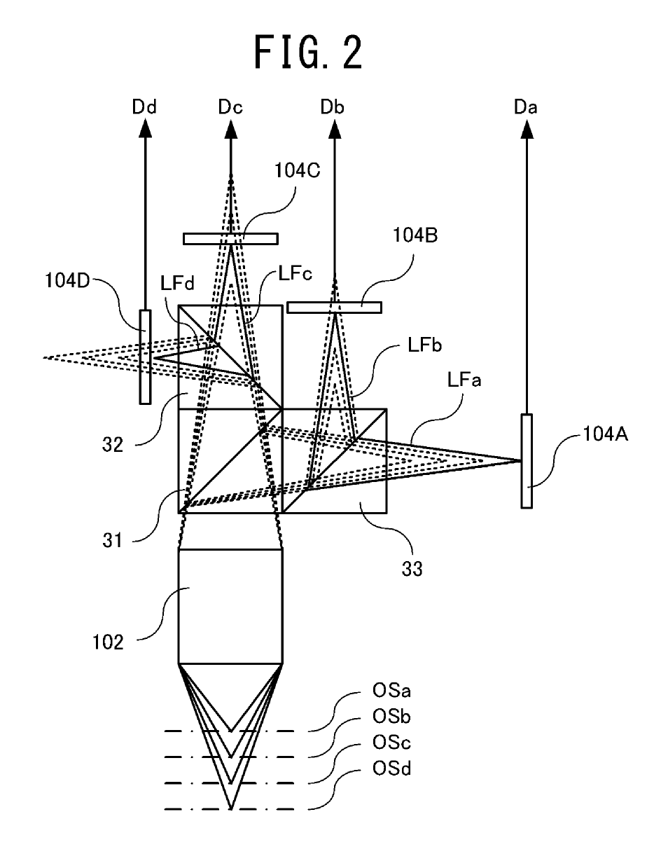

FIG. 2 is a view showing an arrangement of the objective lens 102, the optical path splitting unit 103, and the imaging units 104A to 104D used to photograph the four reference planes. The optical path splitting unit 103 is constituted by three beam splitters 31 to 33 disposed on an image side of the objective lens 102.

As shown in FIG. 2, the four reference planes of the objective lens 102 are set as OSa to OSd, in order from a side near the objective lens 102. The respective light receiving surfaces of the imaging units 104A to 104D are disposed in optically conjugate positions relative to the positions of the reference planes OSa to OSd. In other words, luminous flux LFa from the reference plane OSa is reflected by the beam splitter 31 so as to pass through the beam splitter 33 and form an image on the light receiving surface of the imaging unit 104A. Luminous flux LFb from the reference plane OSb is reflected respectively by the beam splitter 31 and the beam splitter 33 so as to form an image on the light receiving surface of the imaging unit 104B. Luminous flux LFc from the reference plane OSc passes through the beam splitter 31 and the beam splitter 32 so as to form an image on the light receiving surface of the imaging unit 104C. Luminous flux LFd from the reference plane OSd passes through the beam splitter 31 so as to be reflected by the beam splitter 32 and form an image on the light receiving surface of the imaging unit 104D. The imaging units 104A to 104D respectively output imaging data Da to Dd in response to a control command from the control unit 106.

When the Z position of a desired layer of the specimen is aligned with the uppermost reference plane OSa by the stage 105, the imaging data Da focusing on the layer are acquired from the imaging unit 104A. At the same time, the imaging data Db to Dd of three layers removed from this layer by respective predetermined distances (respective distances of the reference planes OSb to OSd from the reference plane OSa) are acquired from the imaging units 104B to 104D.

Here, an interval between the reference planes OSa to OSd is preferably set to be equal to or smaller than the depth of field of the objective lens 102. In so doing, an image focusing on a structure in the specimen can always be acquired from one of the imaging units, and therefore high-resolution images of multiple layers can be acquired in the height direction. In this embodiment, the interval between the reference planes OSa to OSd is set to be smaller than the depth of field of the objective lens 102.

Furthermore, in this embodiment, as an example, four layers can be photographed simultaneously using the three beam splitters and the four imaging units, but the present invention is not limited thereto, and instead, for example, two layers may be photographed simultaneously using a single beam splitter and two imaging units. Alternatively, three layers may be photographed simultaneously using a single dichroic mirror and three imaging units. A configuration in which five or more layers are photographed simultaneously may also be employed. Hence, the number of simultaneously photographed layers can be determined appropriately in accordance with the depth of focus of the objective lens 102, the shape and configuration of the optical path splitting unit 103, and so on.

Note that the imaging units 104A and 104D in particular, which are used to compare image data when detecting positional deviation, as described below, are preferably disposed in positions where maintenance thereof can be performed easily.

(Functions of Control Unit)

The control unit 106 acquires divided images on an observation subject layer of the slide 101 by controlling the stage 105 and the imaging units 104A to 104D in sequence.

Further, on the basis of the divided images, the control unit 106 detects imaging position deviation (XY deviation) between the images in the XY direction, which occurs as the stage 105 undergoes Z movement (i.e. as the Z relative position is modified). The control unit 106 then corrects the XY deviation.

Furthermore, the control unit 106 generates omnifocal image data, in which all locations of the divided region are in focus, and three-dimensional image data, from which a shape distribution in the thickness direction can be learned, by performing image synthesis processing to synthesize the plurality of divided images captured in different Z direction positions.

Moreover, the control unit 106 outputs the omnifocal image data, the three-dimensional image data, or synthesized image data obtained therefrom, as the image data for display. The synthesized image data are image data obtained by synthesizing a plurality of omnifocal image data or a plurality of three-dimensional image data having different XY relative positions.

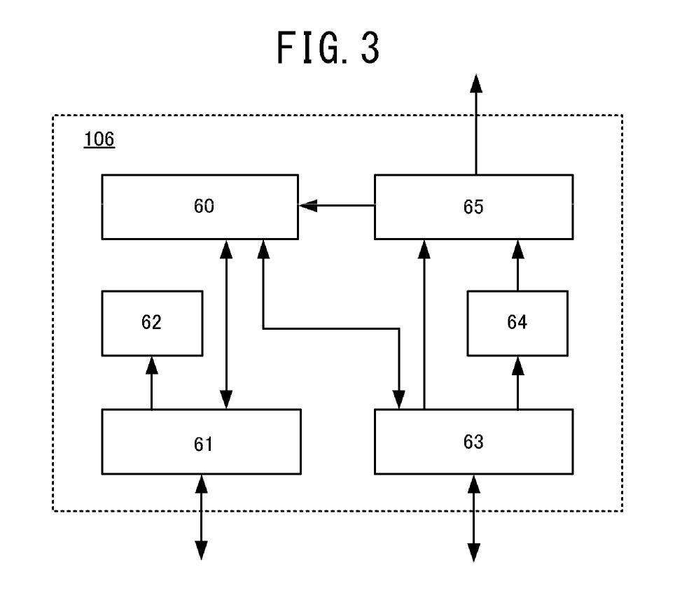

FIG. 3 is a block diagram showing the functions of the control unit 106. As shown in FIG. 3, the control unit 106 is constituted by a main control unit 60, a stage position control unit 61, a movement direction determination unit 62 serving as determining means, an imaging control unit 63, a positional deviation detection unit 64 serving as detecting means, and an image data processing unit 65 serving as correcting means.

The main control unit 60 performs overall control of operations of the respective units constituting the image acquisition apparatus 100. For example, the main control unit 60 performs synchronization processing to acquire an image on which XY deviation has been corrected, generate the omnifocal image data, the three-dimensional image data, or the synthesized image data thereof, and output the generated data as the image data for display. The main control unit 60 is also capable of adjusting the respective units of the image acquisition apparatus 100 while acquiring images of the specimen, for example by performing modulation control on a light source, not shown in the drawings, and switching various optical elements, and of notifying the user of conditions of the respective units as appropriate.

The stage position control unit 61 controls XY movement and Z movement of the stage 105 successively via an output interface on the basis of the respective movement sequences (control target value tables) thereof. The stage position control unit 61 thus feeds the observation subject layer of the desired divided region of the slide 101 to the position of one of the reference planes OSa to OSd. The stage position control unit 61 also acquires XYZ position coordinates of the stage 105 via an input interface.

Further, the stage position control unit 61 determines the Z movement sequence (the control target value table used to Z-move the stage 105) on the basis of the Z acquisition subject range of the specimen, a movement direction determined by the movement direction determination unit 62, and the current Z position (an initial position) of the Z stage. The Z acquisition subject range is the imaging subject range in the optical axis direction. In this embodiment, a target position of a first Z movement is determined to correspond to an end, from among the two ends of the Z acquisition subject range, on a side in an opposite direction to the movement direction determined by the movement direction determination unit 62. Further, target positions of a second Z movement onward are determined successively such that the position in the Z acquisition subject range corresponding to the target position moves in the movement direction determined by the movement direction determination unit 62. The target positions of the second Z movement onward are determined such that a minimum value of a Z direction distance between one of four positions in the Z acquisition subject range in which the four reference planes OSa to OSd exist following modification of the Z position and one of four positions in the Z acquisition subject range in which the four reference planes OSa to OSd exist prior to modification of the Z position is equal to or smaller than a first threshold. By determining a plurality of target positions (Z movement target positions) corresponding to a plurality of positions from one end to the other end of the Z acquisition subject range, the Z movement sequence is generated. As a result, images can be acquired over the entire Z acquisition subject range (the entire imaging subject range) by moving the Z stage in a fixed direction.

The stage position control unit 61 is also capable of determining when and from which imaging units were acquired two sets of image data corresponding respectively to positions of pre-modification reference planes and post-modification reference planes within the Z acquisition subject range in which the minimum value of the Z direction distance is equal to or smaller than the first threshold. The pre-modification reference planes are the reference planes prior to modification of the Z relative position, and the post-modification reference planes are the reference planes following modification of the Z relative position.

The movement direction determination unit 62 determines the movement direction of the Z stage (the modification direction of the Z relative position) on the basis of the Z acquisition subject range of the specimen and the current Z position (the initial position) of the Z stage. In this embodiment, distances between one end of the Z acquisition subject range and the four reference planes OSa to OSd of the Z stage in the current Z position are compared with distances between the other end of the Z acquisition subject range and the four reference planes OSa to OSd of the Z stage in the current Z position. A direction in which the Z relative position is shifted from the end (the end of the Z acquisition subject range) corresponding to the shorter of the two distances toward the end corresponding to the longer distance is then determined as the movement direction of the Z stage. Alternatively, a desired direction may be used as the Z movement direction on the basis of an instruction from the user, without performing this comparison.

The imaging control unit 63 controls imaging by the imaging units 104A to 104D via an input/output interface in synchronization with the completion of movement of the stage 105, and obtains the group of image data Da to Dd. The imaging control unit 63 also acquires position information corresponding to the image data. The position information is information expressing imaging positions of the image data. More specifically, the position information is information expressing the divided region (the XY position) and the observation subject layer (the Z position) of the slide 101 in which the image was captured. The position information can be acquired on the basis of XYZ position coordinates serving as a control target of the stage 105, XYZ position coordinates of the stage 105 after being moved, and so on, for example. The imaging control unit 63 then outputs the image data and the position information in association. A method of attaching identical header information to the corresponding image data and position information, for example, may be used as an association method. The header information is preferably unique information such as a time stamp. Alternatively, the position information to be associated with the image data may be attached to the image data as the header information.

The positional deviation detection unit 64 detects the XY deviation in synchronization with the completion of movement of the Z stage. More specifically, the positional deviation detection unit 64 determines when and from which imaging units were acquired the two sets of image data corresponding respectively to the reference planes before and after modification of the relative position in which the minimum value of the Z direction distance is equal to or smaller than the first threshold. By comparing the two sets of image data corresponding respectively to the pre-modification and post-modification reference planes in which the minimum value of the Z direction distance is equal to or smaller than the aforesaid first threshold, the XY deviation is detected. In this embodiment, the Z relative position is modified such that a Z direction distance between the position within the Z acquisition subject range of the reference plane, among the four reference planes prior to modification of the Z relative position, disposed at the end in the optical axis direction and the position within the Z acquisition subject range of the reference plane, among the four reference planes following modification of the Z relative position, disposed at the end in the optical axis direction is equal to or smaller than the first threshold. More specifically, when the Z relative position is modified in a first direction, the Z relative position is modified such that a Z direction distance between the position within the Z acquisition subject range of the pre-modification reference plane disposed at the end on a first direction side and the position within the Z acquisition subject range of the post-modification reference plane disposed at the end on a side of a second direction, which is an opposite direction to the first direction, is equal to or smaller than the first threshold. When the Z relative position is modified in the second direction, the Z relative position is modified such that a Z direction distance between the position within the Z acquisition subject range of the pre-modification reference plane disposed at the end on the second direction side and the position within the Z acquisition subject range of the post-modification reference plane disposed at the end on the first direction side is equal to or smaller than the first threshold. The first direction is the optical axis direction, which extends from the specimen toward the objective lens 102. Accordingly, a configuration in which input into a comparator is switched to either the image data Da and the buffered image data Dd or the image data Dd and the buffered image data Da in accordance with the movement direction determined by the movement direction determination unit 62 may be employed.

Z direction deviation causes a small difference between the two sets of image data corresponding respectively to the pre-modification and post-modification reference planes in which the minimum value of the Z direction distance is equal to or smaller than the first threshold, whereas XY direction deviation causes a large difference. Therefore, by comparing the two sets of image data as described above, the XY deviation can be detected. There are no particular limitations on a method of detecting the XY deviation. For example, processing to detect (extract) respective feature points of the two sets of image data may be performed, and the XY deviation may be detected by comparing the feature points between the two sets of image data. The XY deviation may also be detected by performing simple region matching using an index such as a sum of absolute differences. More specifically, a region A2 is set in relation to one set of image data A1 among the two sets of image data, and a region B2 (of an identical size to the region A2) is set in relation to another set of image data B1. An absolute value of a pixel value difference between the two sets of image data is then calculated for each pixel within the set regions, whereupon a sum of the calculated absolute values is calculated. Processing for setting a region in the image data B1 and calculating the sum of absolute values is then repeated. A region B3 in which the calculated sum of absolute values reaches a minimum can then be detected as a region corresponding to the region A2, and therefore an XY direction deviation between the region A2 and the region B3 can be detected as the XY deviation. When region matching is employed in this manner, the XY deviation can be detected without detecting (a large number of) complicated feature points.

The first threshold is preferably no larger than the depth of field of the objective lens 102, and particularly preferably zero. As the first threshold decreases, the difference between the two sets of image data expresses a difference caused by XY direction deviation more closely. The XY deviation can therefore be detected with a steadily higher degree of precision as the first threshold decreases. In this embodiment, an example of a case in which zero is used as the first threshold will be described.

Note that the first threshold may be set at a fixed value determined in advance by a manufacturer or the like, or may be modified by the user.

Note that the image data may be associated with the position information and the information indicating when and from which imaging units the image data were acquired, and the resulting associated data may be output to a separate image processing apparatus to the image acquisition apparatus 100 via an output interface. The separate image processing apparatus to the image acquisition apparatus 100 may then detect the XY deviation, correct the XY deviation, generate the omnifocal image data, the three-dimensional image data, or the synthesized image data thereof, and so on.

Alternatively, the image data may be associated with the position information and information expressing the detected XY deviation, and the resulting associated data may be output to a separate image processing apparatus to the image acquisition apparatus 100 via an output interface. The separate image processing apparatus to the image acquisition apparatus 100 may then correct the XY deviation, generate the omnifocal image data, the three-dimensional image data, or the synthesized image data thereof, and so on. The information expressing the XY deviation may be associated with the image data only when the image data corresponding to the reference planes following modification of the Z position are output.

The image data processing unit 65 generates a group of corrected image data by correcting the XY positions of the group of image data Da to Dd acquired after moving the Z stage on the basis of the detected XY deviation in synchronization with the completion of movement of the Z stage. For example, the image data processing unit 65 shifts each pixel position of the group of image data Da to Dd acquired after moving the Z stage by an amount corresponding to the detected XY deviation. As a result, the detected XY deviation is reduced. Note that the XY positions expressed by the position information acquired in association with the image data may be shifted by an amount corresponding to the detected XY deviation. A group of image data having shifted pixel positions may then be generated during subsequent synthesis processing and display processing, for example.

Groups of corrected image data in which the XY positions are aligned relative to the XY positions prior to movement of the Z stage are generated repeatedly in this manner, whereby a group of a plurality of images in which imaging position deviation occurring in the XY direction during modification of the Z position is corrected can be acquired over multiple layers of the specimen.

Note that the position information and the group of corrected image data may be associated with each other and output via the output interface to a separate image processing apparatus to the image acquisition apparatus 100. The separate image processing apparatus to the image acquisition apparatus 100 may then generate the omnifocal image data, the three-dimensional image data, or the synthesized image data thereof.

Further, the image data processing unit 65 generates the omnifocal image data and/or the three-dimensional image data on the basis of the group of corrected image data and the position information thereof in synchronization with the completion of image acquisition within the Z acquisition subject range. The omnifocal image data are constructed by calculating a derivative value or a differential value of a brightness of each pixel of the divided image relative to that of an adjacent pixel, setting a resulting value as an evaluation value, comparing the evaluation value with the evaluation values of the other image data acquired from the Z acquisition subject range, and setting the pixel having the highest evaluation value as data representing a focal point in that pixel position. The three-dimensional image data can be constructed on the basis of the Z coordinates of the respective pixels set as the focal points. Alternatively, the three-dimensional image data may be generated by mapping each pixel of the group of imaging data in a voxel space. Alternatively, the image data of the plurality of layers and the XYZ positions may be associated with each other (in the form of a Z stack image) so that the image displayed during display processing can be switched to the image data of an XYZ position specified by the user.

Furthermore, the image data processing unit 65 generates synthesized image data on the basis of the omnifocal image data and/or the three-dimensional image data in each divided region, and the XY positions thereof, in synchronization with the completion of image acquisition within the Z acquisition subject range. The synthesized image data are image data expressing the entire region of the XY acquisition subject range of the slide 101, and are generated by positioning and connecting the divided image data from the respective divided regions. Any connection method, such as joining (tiling), superimposing (blending overlapping parts of adjacent images), or connecting the images smoothly through interpolation processing, may be used. Similarly to the corrected image data, connection information (information expressing an amount by which the pixel position is shifted during connection) may be reflected in the position information acquired in association with the image data. A group of image data in which the pixel positions are shifted may then be generated and displayed in accordance with the connection information during the display processing.

Hence, the image data processing unit 65 generates image data for display (observation image data) such as the omnifocal image data, the three-dimensional image data, and the synthesized image data using the group of imaging data. The image data processing unit 65 then outputs the image data for display via the output interface so that the image data can be displayed on the display unit 107. Note that the order in which the omnifocal image data or the three-dimensional image data and the synthesized image data are generated may be reversed. In other words, synthesized image data for each layer may be generated by connecting the imaging data from each divided region, whereupon the omnifocal image data or the three-dimensional image data are generated from synthesized image data relating to a plurality of layers. Note that the method of generating the image data for display described above is merely an example, and another image processing method may be used. Further, the image data processing unit 65 may generate image data for display other than the data described above, for example extracted image data emphasizing an image feature that is beneficial for observation and diagnosis, image data having a modified sight line direction (observation direction), and so on.

Moreover, the image data processing unit 65 calculates the Z acquisition subject range from the group of generated image data Da to Dd. For example, the image data processing unit 65 performs autofocus processing via the stage position control unit 61 and the imaging control unit 63, and calculates a similar evaluation value to that used to generate the omnifocal image data for each generated piece of image data. The image data processing unit 65 then determines a Z range that includes a location having a high evaluation value as the Z acquisition subject range. An interval by which the Z stage is moved to generate the group of image data Da to Dd may also be modified appropriately by the main control unit 60.

(Hardware Configuration of Control Unit)

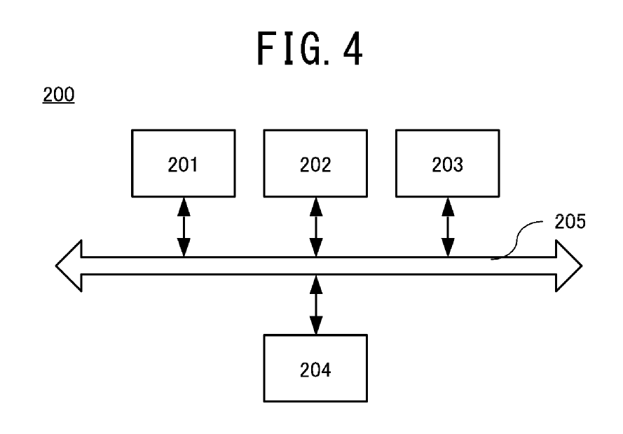

FIG. 4 is a block diagram showing a hardware configuration of the control unit 106.

A personal computer (PC) 200, for example, is used as the control unit 106. The PC 200 includes a central processing unit (CPU) 201, a hard disk drive (HDD) 202, a random access memory (RAM) 203, an input/output I/F 204, and a bus 205 that connects these components to each other.

The CPU 201 performs overall control of the entire PC 200 while accessing the RAM 203 and so on as required, and performing various types of calculation processing. The HDD 202 is an auxiliary storage apparatus storing programs executed by the CPU 201, various parameters, and so on. The imaging data acquired from the imaging units, the generated omnifocal image data, three-dimensional image data, synthesized image data, and data for display, and so on may be stored in the HDD 202. The RAM 203 is used as a working area of the CPU 201 and so on, and temporarily holds various programs that are underway, and various data to be processed by the control unit 106.

The input/output I/F 204 may be constituted by a universal interface using optical communication, Gigabit Ethernet (registered trademark), a universal serial bus (USB), Peripheral Component Interconnect Express (PCIE) (registered trademark), a digital visual interface (DVI), and so on. The stage 105, the imaging units 104A to 104D, the display unit 107, an input apparatus, not shown in the drawings, and so on are connected to the input/output I/F 204. An image server storing the generated data for display and various other data may be connected to the input/output I/F 204. In FIG. 1, a configuration in which the display unit 107 is connected as an external apparatus is envisaged, but the control unit 106 and the display unit 107 may be constituted by a single apparatus using a PC having an integrated display apparatus. The input apparatus is a pointing device such as a mouse, a keyboard, a touch panel, or another operation input apparatus, for example. A device that doubles as the display unit 107 and the input apparatus, such as a touch panel display, may also be used.

(Relationship Between Observation Subject Layer of Specimen and Reference Planes)

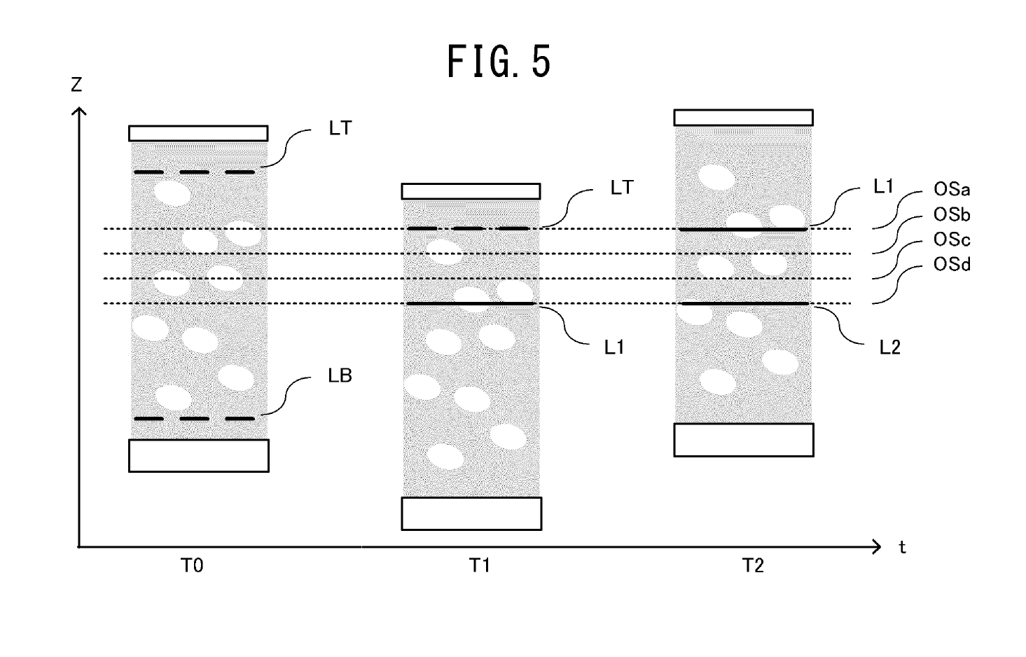

FIG. 5 is a view showing a correspondence relationship between the four reference planes OSa to OSd corresponding to the four groups of imaging data Da to Dd and the specimen (the Z acquisition subject range).

LT denotes an upper end (an upper end layer) of the Z acquisition subject range, and LB denotes a lower end (a lower end layer) of the Z acquisition subject range.

A condition (the correspondence relationship between the reference planes OSa to OSd and the Z acquisition subject range) at a time T0 corresponds to a condition established when the acquisition subject divided region has been fed into the visual field of the objective lens 102 by moving the XY stage. In other words, the condition at the time T0 is a condition established when the Z relative position is in the initial position. In the example of FIG. 5, no reference plane is aligned with the Z position of either the upper end LT or the lower end LB at the time T0. As will be described in detail below, in this embodiment, a distance from the reference plane OSa to the upper end LT when the Z relative position is in the initial position is compared with a distance from the reference plane OSd to the lower end LB when the Z relative position is in the initial position. A direction in which the Z relative position is shifted from the end corresponding to the shorter of the two distances toward the end corresponding to the longer distance is then determined as the movement direction of the Z stage. In the example of FIG. 5, therefore, a direction in which the Z relative position is shifted from the upper end LT to the lower end LB is determined as the movement direction of the Z stage. In other words, an upward direction of the Z stage is determined as the movement direction of the Z stage.

A condition at a time T1 corresponds to a condition established when the Z position of the upper end LT has been fed to the Z position of the reference plane OSa. At this time, image data in which the upper end layer LT serving as the observation subject layer is within the depth of field are output from the imaging unit 104A as Da (T1), and image data in which an observation subject layer L1 is within the depth of field are output from the imaging unit 104D as Dd (T1). Similarly, the image data Db (T1) in which the observation subject layer is within the depth of field are output from the imaging unit 104B, and the image data Dc (T1) in which the observation subject layer is within the depth of field are output from the imaging unit 104C.

A condition at a time T2 corresponds to a condition in which the Z relative position has been modified from the time T1. In this embodiment, as described above, the Z relative position is modified such that the observation subject layer in the position of the pre-modification reference plane disposed at the end on the side of the opposite direction to the modification direction of the Z relative position is aligned with the observation subject layer in the position of the post-modification reference plane disposed at the end on the modification direction side. In the example of FIG. 5, therefore, the Z position of the observation subject layer L1 is fed from the Z position of the reference plane OSd to the Z position of the reference plane OSa by moving the Z stage. At this time, image data in which the observation subject layer L1 is within the depth of field are output from the imaging unit 104A as Da (T2). In other words, the imaging unit 104A outputs image data of an identical observation subject layer to the image data Dd (T1) output from the imaging unit 104D at the time T1. Image data in which an observation subject layer L2 is within the depth of field are output from the imaging unit 104D as Dd (T2). Similarly, the image data Db (T2) in which the observation subject layer is within the depth of field are output from the imaging unit 104B, and the image data Dc (T2) in which the observation subject layer is within the depth of field are output from the imaging unit 104C.

This operation is repeated until the Z position of the lower end LB has been fed to the Z position of one of the reference planes OSa to OSd. As a result, in-focus image data are acquired from one of the imaging units 104A to 104D in relation to each position within the Z acquisition subject range.

Note that the two reference planes (the pre-modification reference plane and the post-modification reference plane) on which the observation subject layer is aligned need not be the reference planes disposed at the ends. However, by modifying the Z relative position such that the observation subject layer on the post-modification reference plane disposed at the end on the side of the opposite direction to the modification direction of the Z relative position is aligned with the observation subject layer on the pre-modification reference plane disposed at the end on the modification direction side, a modification amount of the Z relative position can be increased, and as a result, a number of modifications of the Z relative position (a number of movements of the Z stage) required to scan the entire Z acquisition subject range can be reduced. Moreover, the Z range of the observation subject layer in which images can be acquired simultaneously can be enlarged.

Furthermore, the observation subject layer on the post-modification reference plane does not have to be aligned with the observation subject layer on the pre-modification reference plane. In this case, the Z relative position is preferably modified such that the observation subject layer on the post-modification reference plane disposed at the end on the side of the opposite direction to the modification direction of the Z relative position is positioned further toward the modification direction side than the observation subject layer on the pre-modification reference plane disposed at the end on the modification direction side. In the example of FIG. 5, the Z relative position is preferably moved downward at the time T2. In so doing, the modification amount of the Z relative position can be increased, enabling a reduction in the number of modifications of the Z relative position (the number of movements of the Z stage) required to scan the entire Z acquisition subject range. Moreover, the Z range of the observation subject layer in which images can be acquired simultaneously can be enlarged.

(Image Acquisition Method)

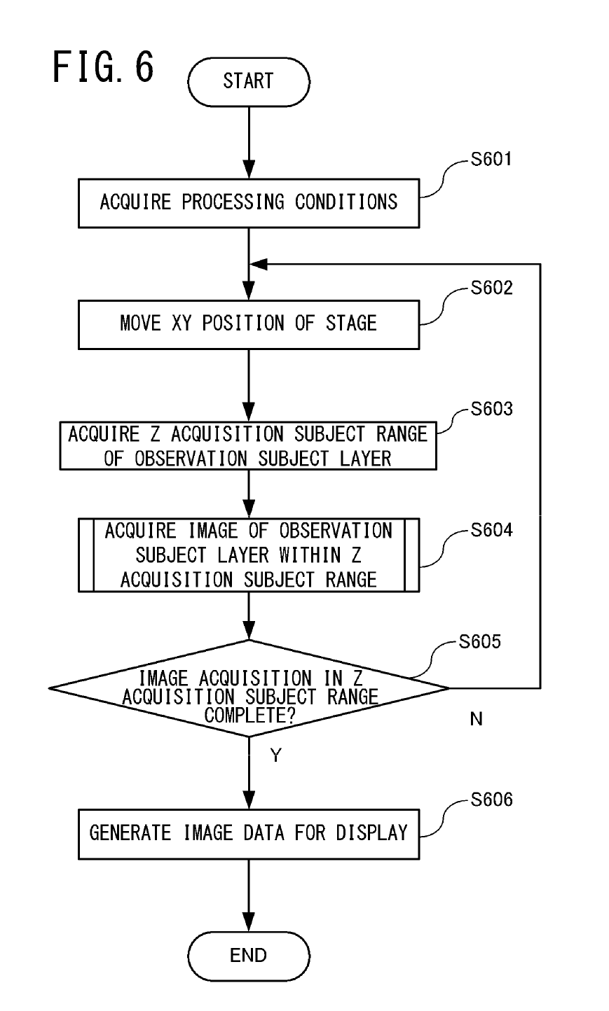

An image acquisition method of the image acquisition apparatus 100 according to this embodiment will now be described using a flowchart shown in FIG. 6.

First, in step S601, the main control unit 60 acquires processing conditions (the XY acquisition subject range and so on) of the image acquisition apparatus 100. Further, the main control unit 60 calculates the XY movement sequence (the XY stage control target value table) of the stage on the basis of the XY acquisition subject range. The table describes control target values of the XY stage for moving the plurality of divided regions on the slide 101 into the visual field of the objective lens 102 in order to photograph the respective divided regions in order. Note that a size of each divided region corresponds to a size of an effective imaging region of the imaging units when projected onto the object side of the objective lens 102.

Next, in step S602, the main control unit 60 controls the stage 105 via the stage position control unit 61 on the basis of the XY movement sequence (for example, by reading a target value described on a first line of the XY stage control target value table). The main control unit 60 also obtains the XY position coordinates of the moved stage 105.

Next, in step S603, the main control unit 60 obtains the Z acquisition subject range of the divided region corresponding to the current XY position.

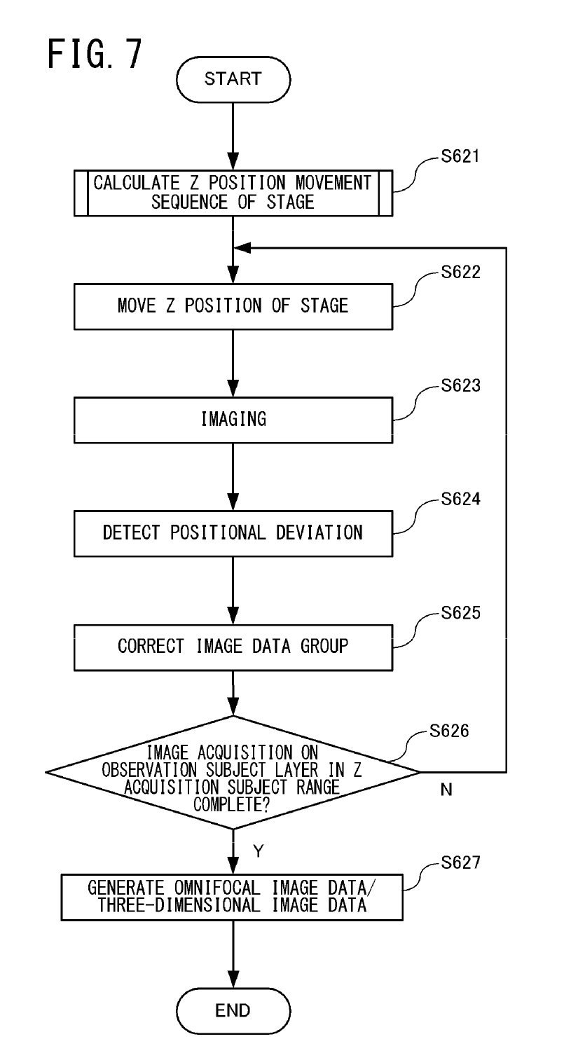

Next, in step S604, the main control unit 60 executes the multi-layer image acquisition processing via the stage position control unit 61, the movement direction determination unit 62, the imaging control unit 63, the positional deviation detection unit 64, and the image data processing unit 65. As a result, images of a plurality of observation subject layers within the Z acquisition subject range are acquired. This step will be described in detail below using FIG. 7.

Next, in step S605, the main control unit 60 determines whether or not image acquisition within the XY acquisition subject range is complete (i.e. has been executed up to a final line of the XY stage control target value table). When the main control unit 60 determines that image acquisition is complete, the processing advances to step S605. When the main control unit 60 determines that image acquisition is not yet complete, the processing returns to step S602, where the main control unit 60 advances to the next line to be read from the XY stage control target value table and continues to control the stage 105 via the stage position control unit 61.

Next, in step S606, the main control unit 60 controls generation of the image data for display via the image data processing unit 65, whereupon image acquisition is terminated.

(Method of Acquiring Images of Observation Subject Layers in Z Acquisition Subject Range)

A method of acquiring images of the observation subject layers in the Z acquisition subject range will now be described in detail using a flowchart shown in FIG. 7.

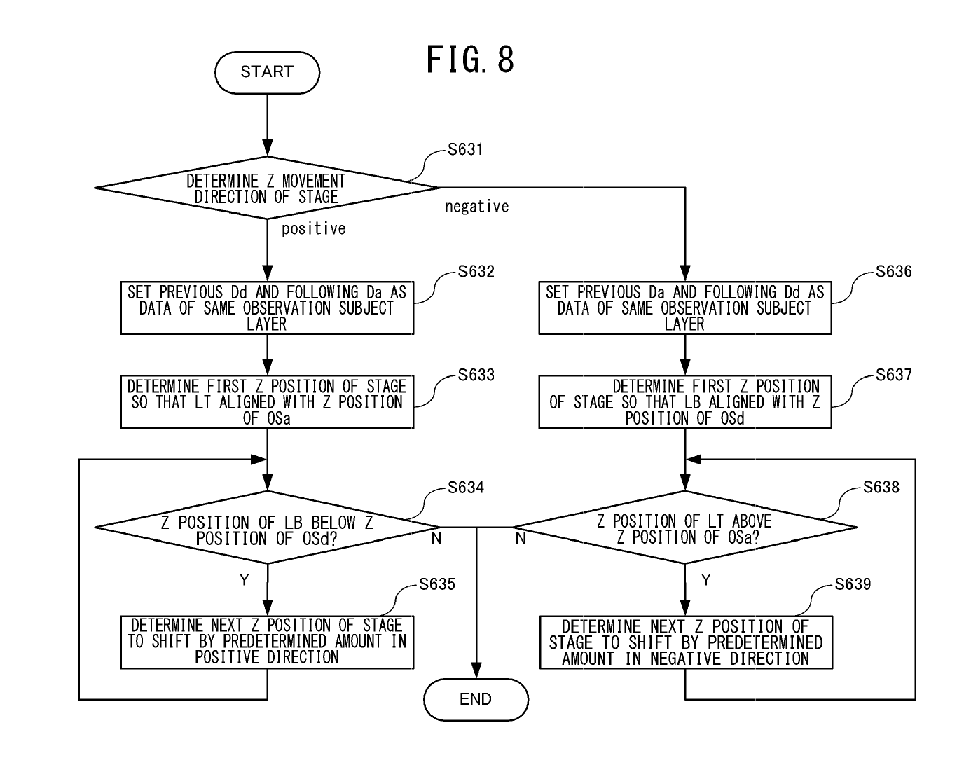

First, in step S621, the stage position control unit 61 calculates the Z movement sequence (the Z stage control target value table) of the stage on the basis of the Z acquisition subject range. This step will be described in detail below using FIG. 8.

Next, in step S622, the stage position control unit 61 controls the stage 105 on the basis of the Z movement sequence (for example, by reading a target value described on a first line of the Z stage control target value table). The stage position control unit 61 also obtains the Z position coordinate of the moved stage 105.

Next, in step S623, the imaging control unit 63 controls imaging by the imaging units 104A to 104D in synchronization with the Z movement in order to obtain the group of image data Da to Dd. Further, the imaging control unit 63 acquires the position information of the acquired image data, and outputs the acquired image data in association with the acquired position information.

Next, in step S624, the positional deviation detection unit 64 detects the positional deviation (the XY deviation) between the two sets of image data (the pre-modification image data and the post-modification image data in the Z relative position) having the same observation subject layer within the depth of field on the basis of the two sets of image data. In the example of FIG. 5, Dd (T1) and Da (T2) are determined to be the image data having the same observation subject layer within the depth of field at the time T2. Accordingly, Dd (T1) and Da (T2) are compared to detect the XY deviation in Da (T2) to Dd (T2) relative to Da (T1) to Dd (T1).

Here, the image data Da to Dd may be output in association with the position information and the information indicating when and from which imaging units the image data having the same observation subject layer within the depth of field were generated. Alternatively, the image data Da to Dd may be output in association with the position information and the detected XY deviation.

Next, in step S625, the image data processing unit 65 generates a group of corrected image data by correcting the XY positions of the group of image data Da to Dd, acquired after moving the Z stage, on the basis of the detected XY deviation.

Here, the group of corrected image data may be output in association with the position information.

Next, in step S626, the main control unit 60 determines whether or not image acquisition within the Z acquisition subject range is complete (i.e. has been executed up to a final line of the Z stage control target value table). When the main control unit 60 determines that image acquisition is complete, the processing advances to step S627. When the main control unit 60 determines that image acquisition is not yet complete, the processing returns to step S622, where the main control unit 60 advances to the next line to be read from the Z stage control target value table and continues to control the stage 105 via the stage position control unit 61.

Next, in step S627, the main control unit 60 controls generation of the omnifocal image data and/or the three-dimensional image data via the image data processing unit 65, whereupon acquisition of images of the observation subject layers within the Z acquisition subject range is terminated. The omnifocal image data and/or the three-dimensional image data are generated on the basis of the group of corrected image data and the Z position information thereof.

(Method of Calculating Z Movement Sequence of Stage)

A method of calculating the Z movement sequence of the stage will now be described in detail using a flowchart shown in FIG. 8.

First, in step S631, the movement direction determination unit 62 determines the movement direction of the Z stage on the basis of the Z acquisition subject range of the observation subject layer from which an image is to be acquired within the depth of field of the specimen, and the current Z position of the Z stage. In the example of FIG. 5, a difference between the upper end LT and the Z position of the reference plane OSa is compared with a difference between the lower end LB and the Z position of the reference plane OSd at the time T0. When the former is smaller than the latter, “positive (a direction for moving the stage upward; a direction for moving the Z relative position downward)” is acquired as a Z stage movement direction determination result, whereupon the processing advances to step S632. When the latter is smaller than the former, “negative (a direction for moving the stage downward; a direction for moving the Z relative position upward)” is acquired as the Z stage movement direction determination result, whereupon the processing advances to step S636.

Next, in step S632, the positional deviation detection unit 64 performs used data setting such that Da output from the imaging unit 104A and Dd output during an immediately preceding operation from the imaging unit 104D are used as the two sets of image data having the same observation subject layer within the depth of field. In the example of FIG. 5, the used data (the image data used to detect the XY deviation) are set such that Dd (T1) and Da (T2) are used as the image data having the same observation subject layer within the depth of field at the time T2.

Next, in step S633, the stage position control unit 61 determines a first Z stage control target (the target value described on the first line of the Z stage control target value table) such that the Z position of the reference plane OSa is aligned with the upper end LT.

Next, in step S634, the stage position control unit 61 compares the Z position of the lower end LB following movement of the Z stage with the respective Z positions of the reference planes OSa to OSd. The stage position control unit 61 then determines whether or not the lower end LB is positioned between the reference planes OSa to OSd after moving the Z stage. After determining that the lower end LB is positioned between the reference planes OSa to OSd, the stage position control unit 61 terminates calculation of the Z movement sequence of the stage. When the stage position control unit 61 determines that the lower end LB is not positioned between the reference planes OSa to OSd, the processing advances to step S635.

Next, in step S635, the stage position control unit 61 determines the next control target of the Z stage (the target value described on the next line of the of the Z stage control target value table), whereupon the processing advances to step S634. Here, the next control target of the Z stage is determined such that the last determined control target (the target value described on the final line of the Z stage control target value table) is shifted in the positive Z direction by the distance from the reference plane OSa to the reference plane OSd. In the example of FIG. 5, the next control target is determined such that the Z position of the reference plane OSa is aligned with the observation subject layer L1 at the time T2.

In step S636, meanwhile, the positional deviation detection unit 64 performs used data setting such that Dd output from the imaging unit 104D and Da output in the immediately preceding operation from the imaging unit 104A are used as the two sets of image data having the same observation subject layer within the depth of field.

Next, in step S637, the stage position control unit 61 determines the first Z stage control target (the control value described on the first line of the Z stage control target value table) such that the Z position of the reference plane OSd is aligned with the lower end LB.

Next, in step S638, the stage position control unit 61 compares the Z position of the upper end LT following movement of the Z stage with the respective Z positions of the reference planes OSa to OSd. The stage position control unit 61 then determines whether or not the upper end LT is positioned between the reference planes OSa to OSd after moving the Z stage. After determining that the upper end LT is positioned between the reference planes OSa to OSd, the stage position control unit 61 terminates calculation of the Z movement sequence of the stage. When the stage position control unit 61 determines that the upper end LT is not positioned between the reference planes OSa to OSd, the processing advances to step S639.

Next, in step S639, the stage position control unit 61 determines the next control target of the Z stage (the target value described on the next line of the of the Z stage control target value table), whereupon the processing advances to step S638. Here, the next control target of the Z stage is determined such that the last determined control target (the target value described on the final line of the Z stage control target value table) is shifted in the negative Z direction by the distance from the reference plane OSa to the reference plane OSd.

In the example described heretofore, the divided region serving as the image acquisition subject is fed into the visual field of the objective lens 102 using the XY stage, moved to the optimum Z position, and then photographed, whereupon the Z stage is moved in a fixed direction. Instead, however, the divided region may be photographed immediately after being fed, whereupon movement of the Z stage and imaging may be performed repeatedly. In this case, the movement direction of the Z stage may vary. For example, the position of the Z stage may be controlled such that the Z stage is moved toward the lower end of the Z acquisition subject range from a position between the upper end and the lower end, and then moved from the lower end toward the upper end. When the movement direction of the Z stage varies, the imaging units from which the two sets of image data used as the data of the same observation subject layer are output and the timings at which the two sets of image data are output vary according to the movement direction of the Z stage, and therefore processing for determining this variation adaptively may also be performed.

According to the method described above, two images (an image prior to movement of the Z stage and an image following movement of the Z stage) having the same observation subject layer within the depth of field are acquired by an apparatus that is capable of successively acquiring images of multiple layers of the specimen included in the preparation 101. Accordingly, imaging position deviation in the XY direction accompanying movement of the Z stage can be detected by the simple processing of comparing the two images, and as a result, images in which positional deviation between layers in the in-plane direction (the XY direction) has been corrected can be obtained over multiple layers of the specimen. Furthermore, an omnifocal image and a three-dimensional image can be constructed on the basis of the corrected images, and therefore a doctor can obtain cell information in which correlative relationships in a thickness direction are reflected correctly. As a result, the doctor can perform an accurate pathological diagnosis.

### Second Embodiment

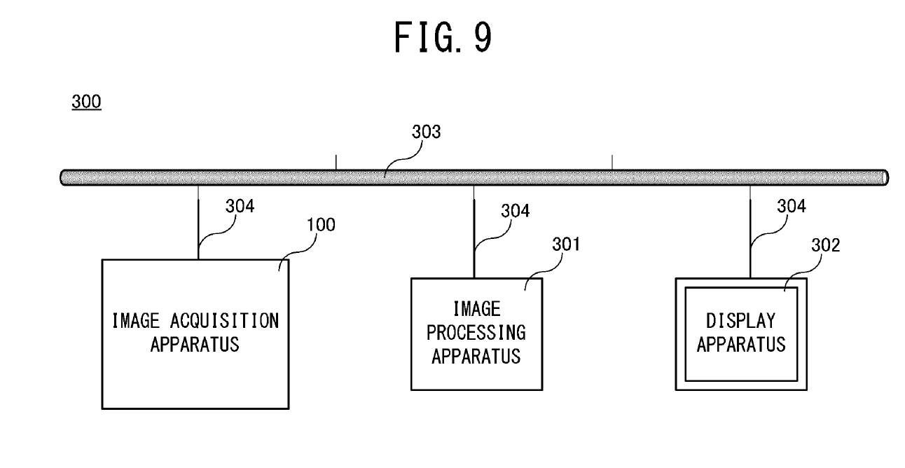

An image acquisition apparatus according to a second embodiment of the present invention will now be described using FIG. 9.

(Configuration of Image Acquisition System)

FIG. 9 is a view showing a configuration of an image acquisition system 300 according to the second embodiment. The configuration of the image acquisition system 300 will now be described on the basis of FIG. 9.

The image acquisition system 300 is constituted by the image acquisition apparatus 100, an image processing apparatus 301, and a display apparatus 302. The image acquisition apparatus 100, the image processing apparatus 301, and the display apparatus 302 are connected to each other communicably via a general-purpose LAN (Local Area Network) cable 304 and a network 303. Note that the image acquisition apparatus 100, the image processing apparatus 301, and the display apparatus 302 may be connected to each other using a general-purpose I/F cable.

The image acquisition apparatus 100 includes, in addition to the functions described in the first embodiment, a function for correcting the imaging position in the XY direction on the basis of the detected XY deviation. More specifically, the image acquisition apparatus 100 has a function for correctively moving the XY position of the preparation 101 on the basis of the detected XY deviation, and reacquiring an image following the correction. To realize this function, the image acquisition apparatus 100 is configured substantially identically to the image acquisition apparatus 100 described using FIG. 1. In order to realize this function, however, the image acquisition apparatus 100 differs from the image acquisition apparatus 100 described using FIG. 1 in terms of the functions of the control unit 106.

(Functions of Control Unit)

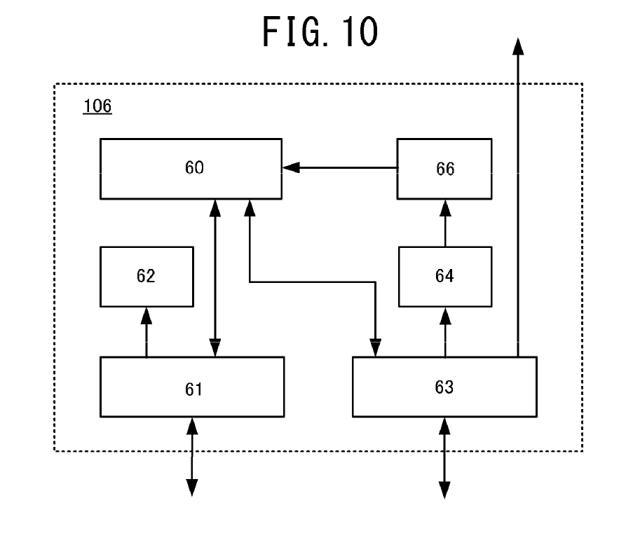

FIG. 10 is a block diagram showing the functions of the control unit 106. As shown in FIG. 10, the control unit 106 is constituted by the main control unit 60, the stage position control unit 61, the movement direction determination unit 62, the imaging control unit 63, the positional deviation detection unit 64, and a reacquisition determination unit 66. The main control unit 60, the stage position control unit 61, the movement direction determination unit 62, the imaging control unit 63, and the positional deviation detection unit 64 have identical functions to the first embodiment, and therefore detailed description thereof has been omitted.

The reacquisition determination unit 66 moves the XY stage correctively on the basis of the detected XY deviation in synchronization with the completion of Z stage movement, and then determines whether or not it is necessary to reacquire the group of image data obtained after moving the Z stage. The need for reacquisition may be determined by comparing the magnitude of the detected XY deviation with a second threshold. In this embodiment, the reacquisition determination unit 66 determines that reacquisition is necessary when the magnitude of the detected XY deviation equals or exceeds the second threshold, and determines that reacquisition is not necessary when the magnitude of the detected XY deviation is smaller than the second threshold. When reacquisition is necessary, the reacquisition determination unit 66 moves the XY stage serving as correcting means correctively by an amount corresponding to the XY deviation via the stage position control unit 61, and then reacquires the group of image data via the imaging control unit 63. In other words, when reacquisition is necessary, the imaging position is corrected in the XY direction on the basis of the XY deviation. After correcting the imaging position, the plurality of image data corresponding to the plurality of reference planes following modification of the Z position are acquired again. The XY coordinates of the stage 105 at this time are coordinates obtained when the XY deviation accompanying movement of the Z stage is corrected, and have no correlation with the divided region serving as the image acquisition subject. Therefore, the XY coordinates of the stage 105 following the corrective movement are preferably not reflected in the XY position information associated with the group of image data generated here. In other words, the XY coordinates of the stage 105 prior to the corrective movement are preferably reflected in the XY position information associated with the group of image data generated here. By moving the XY stage correctively by an amount corresponding to the XY deviation, the XY deviation can be reduced.

Note that in this example, the XY stage is used as the correcting means, but a separate corrective stage may be prepared and controlled. In this case, the corrective stage may have a smaller movable range than the XY stage, but a positioning precision thereof is preferably higher than that of the XY stage.

The second threshold may be a fixed value determined in advance by the manufacturer or the like, or may be a value that can be modified by the user.

By correctively moving the XY position of the preparation 101 and then reacquiring the image in this manner, an effective region (an XY direction region) of the image data that can be used as display data can be widened in comparison with the case described in the first embodiment, in which the pixel positions of the image data are corrected.

The image processing apparatus 301 has a function for processing the image data acquired by the image acquisition apparatus 100. More specifically, the image processing apparatus 301 has the functions of the image data processing unit 65 described in the first embodiment. Note, however, that the image processing apparatus 301 does not correct the image data on the basis of the XY deviation.

The XY deviation may be reduced by both correctively moving the XY stage and correcting the image data. For example, XY deviation (XY deviation remaining after correctively moving the XY stage) that cannot be fully corrected simply by correctively moving the XY stage may be reduced by correcting the image data. Further, the XY stage may be moved correctively when the magnitude of the detected XY deviation equals or exceeds the second threshold, and the image data may be corrected when the magnitude of the detected XY deviation is smaller than the second threshold. Alternatively, a configuration in which the XY stage is moved correctively and the image data are corrected when the magnitude of the detected XY deviation equals or exceeds the second threshold, whereas the image data are corrected when the magnitude of the detected XY deviation is smaller than the second threshold, may be employed.

The display apparatus 302 is equivalent to the display unit 107, and has a function for displaying an observation image suitable for pathological diagnosis on the basis of the image data for display (the observation image data) generated by the image processing apparatus 301. Further, the display apparatus 302 is provided with an input apparatus. The input apparatus is a pointing device such as a mouse, a keyboard, a touch panel, or another operation input apparatus, for example. A device that doubles as the display apparatus 302 and the input apparatus, such as a touch panel display, may also be used. The input apparatus is used by the user to modify the settings of the image acquisition apparatus 100 and the image processing apparatus 301, for example.

The respective constituent elements of the image acquisition system 300 thus configured may be disposed remotely so that the user can perform image acquisition and image display by remote operations.

(Image Acquisition Method)

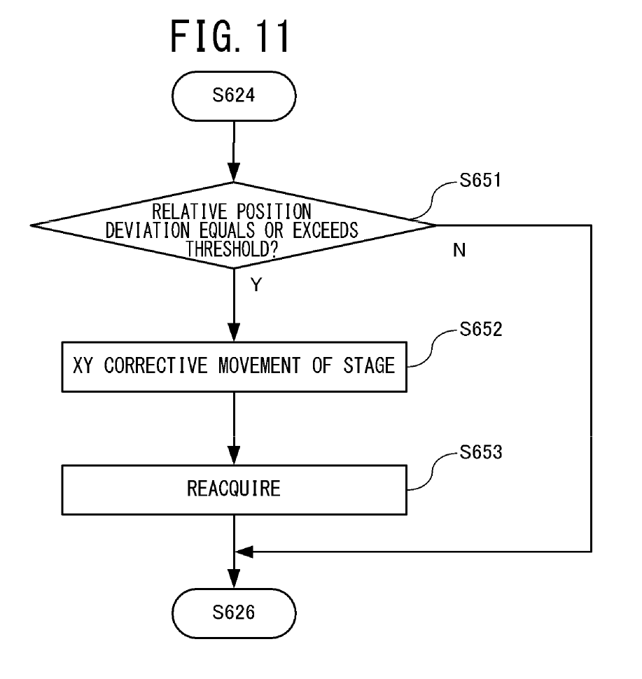

An image acquisition method employed in the image acquisition system 300 according to this embodiment will now be described using a flowchart shown in FIG. 11. Unless noted otherwise, it is assumed that the processing of the respective steps in this flowchart is performed by the control unit 106 of the image acquisition apparatus 100.

First, the XY deviation accompanying movement of the Z stage is detected on the basis of the two sets of image data having the same observation subject layer within the depth of field. More specifically, the processing from step S601 in FIG. 6 to step S624 in FIG. 7 is performed.

Next, in step S651, the reacquisition determination unit 66 compares the detected XY deviation with the second threshold to determine whether or not the magnitude of the XY deviation equals or exceeds the second threshold. When the XY deviation equals or exceeds the second threshold, the processing advances to step S652. When the XY deviation is smaller than the second threshold, on the other hand, the processing advances to step S626, where the processing for acquiring an image in the Z acquisition subject range is continued.

Next, in step S652, the main control unit 60 moves the XY stage correctively by an amount corresponding to the XY deviation via the stage position control unit 61.

Next, in step S653, the main control unit 60 reacquires the group of image data via the imaging control unit 63.

Next, in step S626, similarly to the first embodiment, the main control unit 60 determines whether or not image acquisition within the Z acquisition subject range is complete (i.e. executed to the last line of the Z stage control target value table).

Finally, in step S627, the image processing apparatus 301 performs control to generate omnifocal image data and/or three-dimensional image data on the basis of the group of image data and the Z position information thereof. Acquisition of an image of the observation subject layer within the Z acquisition subject range is then terminated, whereupon the processing advances to step S605 in FIG. 6.

When acquisition of all of the images in the XY acquisition subject range is complete, the image data for display are generated, whereupon the image data for display can be displayed by the display apparatus 302.

According to the method described above, two images (an image prior to movement of the Z stage and an image following movement of the Z stage) having the same observation subject layer within the depth of field are acquired by an apparatus that is capable of successively acquiring images of multiple layers of the specimen included in the preparation 101. Accordingly, imaging position deviation in the XY direction accompanying movement of the Z stage can be detected by the simple processing of comparing the two images, and as a result, images in which positional deviation between layers in the in-plane direction (the XY direction) has been corrected can be obtained over multiple layers of the specimen. Furthermore, an omnifocal image and a three-dimensional image can be constructed on the basis of the corrected images, and therefore a doctor can obtain cell information in which correlative relationships in a thickness direction are reflected correctly. As a result, the doctor can perform an accurate pathological diagnosis.

### Third Embodiment

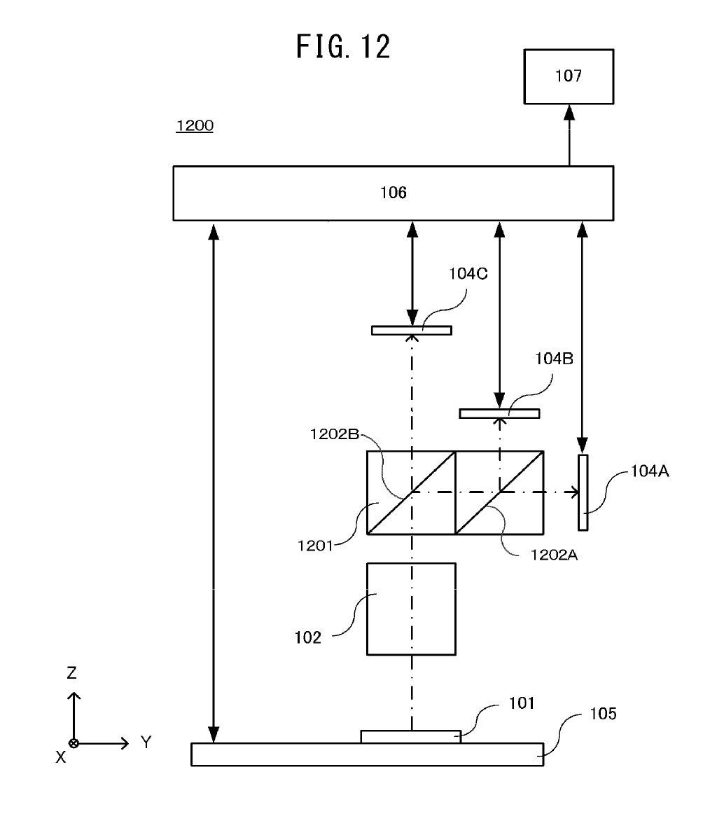

An image acquisition apparatus according to a third embodiment of the present invention will now be described using FIG. 12.

(Configuration of Image Acquisition Apparatus)

FIG. 12 is a view showing a configuration of an image acquisition apparatus 1200 according to the third embodiment. The configuration of the image acquisition apparatus 1200 will now be described on the basis of FIG. 12.

The image acquisition apparatus 1200 includes the objective lens 102, an optical path splitting unit 1201, the imaging units 104A to 104C, the stage 105, the control unit 106, the display unit 107, and a light source unit, not shown in the drawing. Identical configurations to the first embodiment will not be described. The third embodiment differs from the first embodiment in the optical path splitting unit 1201. In the first embodiment, the luminous flux from the objective lens 102 is splitted into four optical paths, whereas in the third embodiment, the luminous flux from the objective lens 102 is splitted by wavelength into three optical paths. More specifically, in the first embodiment, a wavelength for RGB color imaging is selected before switching a light source wavelength and emitting light onto imaging surfaces of the imaging units 104, whereas in the optical path splitting unit 1201, wavelength selection and optical path split are performed simultaneously. The XYZ position of the slide 101 is controlled by moving the stage 105, whereupon three layers of the slide 101 having different heights are photographed simultaneously by the imaging units 104A to 104C via the objective lens 102 and the optical path splitting unit 1201. At this time, imaging is performed at respectively different wavelengths by the imaging units 104A to 104C.

The optical path splitting unit 1201 is an optical system that is held by the main body frame, not shown, or the lens barrel of the objective lens 102 in order to split the wavelength and the luminous flux from the objective lens 102 into three optical paths oriented toward the imaging units 104A to 104C. The optical path splitting unit 1201 is configured and disposed such that the entire visual field of the objective lens 102 is projected onto the respective light receiving surfaces of the imaging units 104A to 104C. Optical path split is performed by half mirrors 1202A and 1202B, and realized by coatings that transmit or reflect white light emitted onto respective transmission/reflection surfaces of the half mirrors 1202A and 1202B via the objective lens 102 at specific wavelengths. As a result, beams having different central wavelengths are projected onto the imaging units 104A to 104C. For example, the respective central wavelengths of RGB are 700 nm for R, 545 nm for G, and 435 nm for B. In this embodiment, a combined unit of two half mirrors is used, but the present invention is not limited thereto, and instead, for example, a combination of two triangular prisms, which is used in a typical RGB three plate system, or a cross dichroic prism may be used. With the configuration described above, differently colored captured images can be acquired simultaneously from three layers (reference planes) having different heights so as to be in focus on each layer.

(Relationship Between Imaging Sequence and Reference Planes)

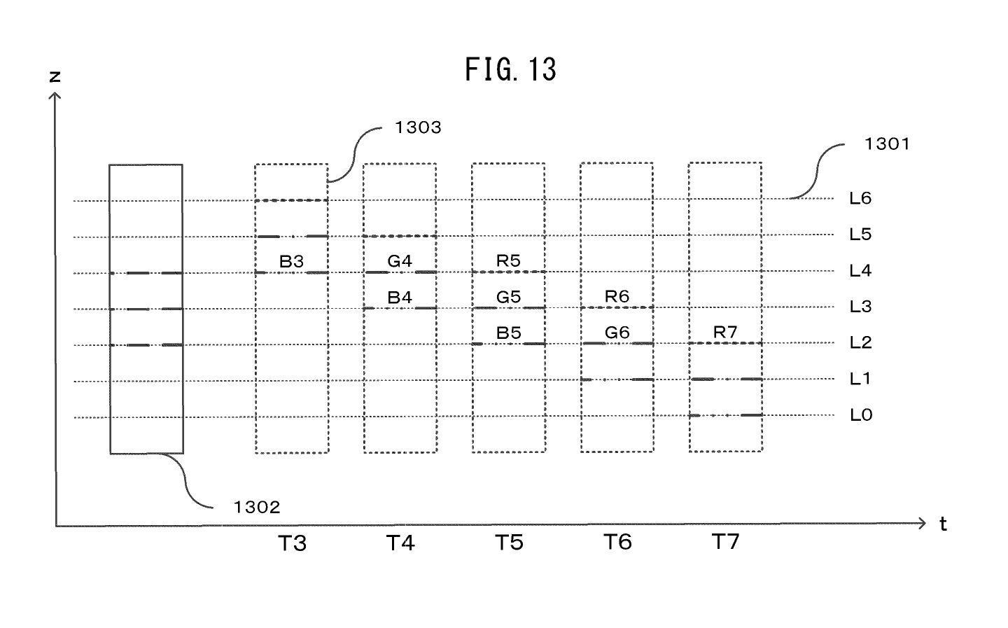

FIG. 13 is a view illustrating a relationship between an imaging sequence and the reference planes according to the third embodiment. A total of seven layers (L0 to L6) are shown as layers 1301 of the specimen in terms of a relationship between a temporal axis t of imaging and a z direction hierarchy. In this embodiment, imaging performed in relation to three layers from L2 to L4 will be described. A range 1302 surrounded by solid lines indicates positional relationships between the three layers when the layers are finally acquired from the specimen. A range 1303 surrounded by dotted lines indicates positional relationships between RGB images acquired by the imaging units 104A to 104C at respective imaging timings. Note that here, it is assumed that the imaging unit 104A captures an R image, the imaging unit 104B captures a G image, and the imaging unit 104C captures a B image.

As shown in FIG. 5, the Z acquisition subject range is determined before the time T2, similarly to the embodiments described heretofore. This embodiment differs in that the captured images used to retrieve the Z acquisition subject range are images acquired at different wavelengths, such as RGB wavelengths. When the specimen is colored, a contrast of each color and acquired form information differ, but by acquiring correlations between the colors, the observation subject layer can be determined. In this embodiment, the upper end (the upper end layer) of the Z acquisition subject range is set at L4, and the lower end (the lower end layer) is set L2. A layer acquisition sequence and positional relationships between the layers from L2 to L4 will be described below. Note that during simultaneous acquisition, an imaging position relationship of the imaging units A to C (R to B) is set such that the imaging unit A is on the upper layer and the imaging unit C is on the lower layer.

At a time T3, imaging in the Z acquisition subject range is started. At the time T3, the Z stage is moved to realize a positional relationship in which the upper layer L4 is photographed by the imaging unit 104C (the B color). Here, a color image B3 is acquired. Next, at a time T4, the Z stage is shifted one layer downward, whereupon simultaneous imaging is performed such that the L4 layer acquired at the time T3 is photographed by the imaging unit 104B (the G color) and the L3 layer is photographed newly by the imaging unit 104C (the B color). The layer is then shifted similarly thereafter such that RGB images of the same layer are acquired at temporal intervals. For example, a color image of the L4 layer is generated from respective color images B3, G4, and R5, acquired respectively at the times T3, T4, and T5. Similarly, a color image of the L3 layer can be acquired from B4, G5, and R6, acquired respectively at the times T4, T5, and T6.

In this embodiment, the imaging positions of the imaging units 104 that acquire images in the respective RGB colors are fixed, but the respective imaging units 104 may be provided with individual stages capable of moving in the optical axis direction so that the individual RGB imaging positions can be modified during each imaging operation. Further, in the first and second embodiments, the imaging positions are not modified for each color, and therefore, depending on the performance of the objective lens 102, the image quality may deteriorate due to axial chromatic aberration and non-axial chromatic aberration of magnification. By determining the imaging positions of the respective imaging units 104 in consideration of the effects of the aberration described above at the time of initial setting and shipment, a favorable observation image exhibiting few effects from color deviation and aberration can be acquired.

According to the method described above, two images (an image prior to movement of the Z stage and an image following movement of the Z stage) having the same observation subject layer within the depth of field are acquired by an apparatus that is capable of successively acquiring images of multiple layers of the specimen included in the preparation 101. Accordingly, imaging position deviation in the XY direction accompanying movement of the Z stage can be detected by the simple processing of comparing the two images, and as a result, images in which positional deviation between layers in the in-plane direction (the XY direction) has been corrected can be obtained over multiple layers of the specimen. Furthermore, by determining an imaging unit 104 for each color, an observation image exhibiting little aberration can be provided. Hence, a low aberration image, which originally often requires a large number of achromatic lenses such as spherical lenses, can be acquired with a simple lens configuration and a small number of lenses. As a result, reductions in the size and cost of the apparatus can be obtained.

### Fourth Embodiment

The image acquisition method according to the present invention may be provided in a system or an apparatus in the form of a recording medium (or a storage medium) on which program code of software for realizing all or a part of the functions of the embodiments described above is recorded. The method may then be realized by having a computer (or a CPU or an MPU) of the system or the apparatus read and execute the program code stored on the recording medium. In this case, the functions of the embodiments described above are realized by the program code read from the recording medium, and the recording medium on which the program code is recorded constitutes the present invention.

Further, when the computer executes the read program code, an operating system (OS) or the like operating on the computer performs all or a part of the actual processing. A case in which the functions of the embodiments described above are realized by this processing is also included in the present invention.

Furthermore, the program code read from the recording medium may be written to a function expansion card inserted into the computer or a memory included in a function expansion unit connected to the computer. A CPU or the like included in the function expansion card or the function expansion unit then performs all or a part of the actual processing on the basis of instructions included in the program code. A case in which the functions of the embodiments described above are realized by this processing is also included in the present invention.

Note that when the present invention is applied to the recording medium described above, program code corresponding to the flowcharts described above is stored in the recording medium.

### Other Embodiments

Preferred embodiments of the present invention were described above, but the present invention is not limited to these embodiments, and various amendments and modifications may be applied thereto within the scope of the spirit of the invention. Further, the configurations described in the first to fourth embodiments may be used in combination with each other. Hence, it would be easy for a person skilled in the art to arrive at a new system by combining the various techniques of the respective embodiments described above appropriately, and systems constituted by these various combinations likewise belong to the scope of the present invention.

For example, as described above, the first threshold may be made modifiable. In other words, the difference (ΔZ) between the Z position of the observation subject layer in the position of the post-modification reference plane and the Z position of the observation subject layer in the position of the pre-modification reference plane may be made modifiable. For example, the Z position to which the observation subject layer L1 is fed by moving the Z stage at the time T2 in FIG. 5 may be set as the Z position of the reference plane OSa+ΔZ, and the value of ΔZ may be made modifiable. In so doing, it is possible to switch between processing for acquiring a high quality image (an image in which the XY deviation is corrected with a high degree of precision) by setting ΔZ at a small value, and processing for acquiring an image at high speed by setting ΔZ at a large value.

Further, the first threshold may be switched between zero and a value that is substantially equal to the depth of field (the arrangement interval of the reference planes OSa to OSd) of the objective lens 102. Control may then be performed such that when the first threshold takes a substantially equal value to the depth of field of the objective lens 102, the XY deviation is not detected, and when the first threshold is zero, the XY deviation is detected. For example, control may be performed to set an equal value to the arrangement interval of the reference planes OSa to OSd as ΔZ under normal conditions so that the XY deviation is not performed, and to set zero as ΔZ in response to environmental variation so that the XY deviation is detected.

In so doing, a frequency with which the Z range of the observation subject layer in which images can be acquired simultaneously narrows due to acquiring images of an identical observation subject layer can be controlled, and as a result, high speed image acquisition can be prioritized when the effect of the XY deviation caused by movement of the Z stage is small or the like. Environmental variation includes temperature variation, the elapsed time of an operation, and so on, for example. Alternatively, processing for setting ΔZ at zero and detecting the XY deviation may be executed as calibration when a power supply is introduced into the apparatus or acquisition of an image of a single preparation starts.

When the detection of the XY deviation is not performed, the imaging position and the image data are corrected on the basis of the most recently detected XY deviation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-50257, filed on Mar. 13, 2014 and Japanese Patent Application No. 2014-260713, filed on Dec. 24, 2014, which are hereby incorporated by reference herein in their entirety.

What is claimed is:

1. An image acquisition apparatus comprising:
an optical system that collects light from a specimen;
a splitting unit that splits an optical path from the optical system into a plurality of optical paths;
a plurality of imaging units that have light receiving surfaces respectively on the plurality of optical paths, a plurality of reference planes, which are specimen side surfaces that are optically conjugate with the respective light receiving surfaces, being positioned at different heights on the specimen side; and
a modifying unit that modifies a relative position between the specimen and the plurality of reference planes in an optical axis direction of the optical system,
wherein the modifying unit modifies the relative position such that a minimum value of a distance in the optical axis direction between one of a plurality of positions within the specimen in which the plurality of reference planes exist following modification of the relative position and one of a plurality of positions within the specimen in which the plurality of reference planes exist prior to modification of the relative position is equal to or smaller than a first threshold, and
the plurality of imaging units acquire a plurality of image data corresponding to the plurality of reference planes in each relative position.

2. The image acquisition apparatus according to claim 1, further comprising an outputting unit that outputs the image data acquired by the imaging unit in association with position information indicating imaging positions of the image data.

3. The image acquisition apparatus according to claim 1, further comprising a detecting unit that detects a deviation in the imaging position in a perpendicular direction to the optical axis direction, which is generated when the relative position is modified, by comparing two sets of image data corresponding respectively to the reference planes prior to and following modification of the relative position in which the distance in the optical axis direction is equal to or smaller than the first threshold.

4. The image acquisition apparatus according to claim 3, further comprising an outputting unit that outputs the image data acquired by the imaging unit, and outputs the image data corresponding to the reference plane following modification of the relative position in association with deviation information indicating the deviation detected by the detecting unit.

5. The image acquisition apparatus according to claim 3, further comprising a correcting unit that corrects the image data corresponding to the reference plane following modification of the relative position so that the deviation detected by the detecting unit is reduced.

6. The image acquisition apparatus according to claim 5, wherein modification of the relative position and acquisition of the plurality of image data are executed repeatedly,
the first threshold can be switched between zero and a value that is substantially equal to a depth of field of the optical system,
the detecting unit does not detect the deviation when the first threshold takes a substantially equal value to the depth of field of the optical system, and detects the deviation when the first threshold is zero, and
when the detecting unit does not detect the deviation, the correcting unit corrects the image data corresponding to the reference plane following modification of the relative position on the basis of a most recently detected deviation.

7. The image acquisition apparatus according to claim 3, further comprising a correcting unit that corrects the imaging position in the perpendicular direction to the optical axis direction so as to reduce the deviation detected by the detecting unit when a magnitude of the deviation detected by the detecting unit equals or exceeds a second threshold,
wherein, following the correction performed by the correcting unit, the plurality of imaging units reacquires the plurality of image data corresponding to the plurality of reference planes following modification of the relative position.

8. The image acquisition apparatus according to claim 7, wherein modification of the relative position and acquisition of the plurality of image data are executed repeatedly,
the first threshold can be switched between zero and a value that is substantially equal to a depth of field of the optical system,
the detecting unit does not detect the deviation when the first threshold takes a substantially equal value to the depth of field of the optical system, and detects the deviation when the first threshold is zero, and
when the detecting unit does not detect the deviation, the correcting unit corrects the imaging position corresponding to the reference plane following modification of the relative position on the basis of a most recently detected deviation.

9. The image acquisition apparatus according to claim 1, wherein the modifying unit modifies the relative position such that a distance in the optical axis direction between a position within the specimen in which a reference plane disposed on an end in the optical axis direction, from among the plurality of reference planes prior to modification of the relative position, exists and a position within the specimen in which the reference plane disposed on the end in the optical axis direction, from among the plurality of reference planes following modification of the relative position, exists is equal to or smaller than the first threshold.

10. The image acquisition apparatus according to claim 1, wherein, when the relative position is modified in a first direction, which corresponds to the optical axis direction and is a direction heading toward the optical system from the specimen, the modifying unit modifies the relative position such that a distance in the optical axis direction between a position within the specimen in which a reference plane disposed on the first direction side end, from among the plurality of reference planes prior to modification of the relative position, exists and a position within the specimen in which a reference plane disposed on an end on a side of a second direction, which is an opposite direction to the first direction, from among the plurality of reference planes following modification of the relative position, exists is equal to or smaller than the first threshold, and
when the relative position is modified in the second direction, the modifying means modifies the relative position such that a distance in the optical axis direction between a position within the specimen in which a reference plane disposed on the second direction side end, from among the plurality of reference planes prior to modification of the relative position, exists and a position within the specimen in which the reference plane disposed on the first direction side end, from among the plurality of reference planes following modification of the relative position, exists is equal to or smaller than the first threshold.

11. The image acquisition apparatus according to claim 1, further comprising a determining unit that determines, as a modification direction of the relative position, a direction heading from one end toward another end of an imaging subject range, which is a range of the optical axis direction, the direction being a direction heading from an end on a side close to the plurality of reference planes corresponding to an initial position of the relative position toward an end on a side far from the plurality of reference planes corresponding to the initial position,
wherein the modifying unit modifies the relative position repeatedly in the modification direction determined by the determining unit so that imaging is performed successively from the end on the side close to the plurality of reference planes corresponding to the initial position, whereby the image data are acquired over an entirety of the imaging subject range.

12. The image acquisition apparatus according to claim 1, wherein the first threshold is equal to or smaller than a depth of field of the optical system.

13. The image acquisition apparatus according to claim 1, wherein the first threshold is modifiable.

14. The image acquisition apparatus according to claim 1, wherein the splitting unit splits a beam from the optical system by wavelength into a plurality of beams having different central wavelengths.

15. A control method of an image acquisition apparatus including:
an optical system that collects light from a specimen;
a splitting unit that splits an optical path from the optical system into a plurality of optical paths; and
a plurality of imaging units that have light receiving surfaces respectively on the plurality of optical paths, a plurality of reference planes, which are specimen side surfaces that are optically conjugate with the respective light receiving surfaces, being positioned at different heights on the specimen side,
the control method comprising the steps of:
modifying a relative position between the specimen and the plurality of reference planes in an optical axis direction of the optical system such that a minimum value of a distance in the optical axis direction between one of a plurality of positions within the specimen in which the plurality of reference planes exist following modification of the reference position and one of a plurality of positions within the specimen in which the plurality of reference planes exist prior to modification of the relative position is equal to or smaller than a first threshold, and
acquiring a plurality of image data corresponding to the plurality of reference planes in each reference position using the plurality of imaging units.
